(19) United States
(12) Patent Application Publication
(10) Pub. No.: US 2013/0303640 A1
(43) Pub. Date: Nov. 14, 2013

(54) Vinyl Chloride Resin Composition Comprising Diethylhexylcyclohexane for Wallpaper

(71) Applicants: Jae Song Kim, Daejeon (KR); Kyong Jun Yoon, Daejeon (KR); Yeon Su Jang, Daejeon (KR); Ki Jo Sim, Gyeongju-si (KR)

(72) Inventors: Jae Song Kim, Daejeon (KR); Kyong Jun Yoon, Daejeon (KR); Yeon Su Jang, Daejeon (KR); Ki Jo Sim, Gyeongju-si (KR)

(73) Assignee: HANWHA CHEMICAL CORPORATION, Seoul (KR)

(21) Appl. No.: 13/980,172

(22) PCT Filed: Jan. 18, 2012
(86) PCT No.: PCT/KR2012/000412

§ 371 Date: Jul. 17, 2013

(30) Foreign Application Priority Data
Jan. 18, 2011 (KR) 10-2011-0004737

(51) Int. Cl. C09D 127/06

(52) U.S. Cl. CPC C09D 127/06
USPC 521/73

(57) ABSTRACT

The present invention relates to a vinyl chloride resin composition containing diethylhexylcyclohexane as a plasticizer. Diethylhexylcyclohexane may replace controversial phthalate based plasticizers to prevent environmental contamination and have significantly low initial viscosity and low-temperature viscosity and a remarkably low low-temperature viscosity with the passage of time as compared to the existing phthalate based plasticizers and dioctyl terephthalate, which is a non-phthalate based plasticizer, such that the vinyl chloride resin composition containing the diethylhexylcyclohexane plasticizer may have excellent workability and generate less volatile organic compounds, thereby making it possible to apply this composition to develop eco-friendly products.

### TECHNICAL FIELD

The present invention relates to a vinyl chloride resin composition, and more particularly, to an eco-friendly vinyl chloride resin composition capable of minimizing an amount of generated volatile organic compounds (VOCS) to have high safety on the environment and not using a phthalate based plasticizer.

### BACKGROUND ART

A vinyl chloride resin, which is an interpolymer containing a vinyl chloride homopolymer and vinyl chloride at a content of 50% or more, is one of the five major thermoplastic plastic resins prepared by suspension polymerization and emulsion polymerization. Among them, a polyvinyl chloride resin prepared by emulsion polymerization is mixed with a plasticizer, a stabilizer, a filler, a blowing agent, a pigment, a viscosity depressant, titanium dioxide (TiO₂), and a sub-material having a specific function and used in a plastisol form in various fields such as a floor material, wallpaper, tarpaulin, artificial leather, toys, a coating material for an under body of a vehicle, or the like, through a coating forming method or mold coating forming method.

Particularly, the wallpaper is a product mainly exposed in residential and office spaces, and 60% or more of the wallpaper is manufactured using the vinyl chloride resin. Recently, a main issue of the wallpaper relates to eco-friendly wallpaper, and standard for judging an eco-friendly property has been determined by a healthy building material (HB) grade (four grades from most excellent, excellent, good, and fair) ranked according to the emission amount of the volatile organic compounds (VOCs) by Korea Air Clean Association and determined whether or not phthalate based plasticizers (particularly, di-2-ethylhexyl phthalate (DEHP), butyl benzyl phthalate (BBP), and di-n-butyl phthalate (DBP)) that are considered as substances suspected as environmental hormones in the nation are present.

Describing a manufacturing process of the wallpaper using the vinyl chloride resin, after the plastisol is prepared by mixing solid raw materials including the vinyl chloride resin, the filler, and the pigment and liquid raw materials including the plasticizer, the stabilizer, and the viscosity depressant, this plastisol is coated onto paper and subjected to a gelling process, a printing process, a foaming process, and an embossing process, thereby manufacturing the vinyl chloride based wallpaper. In this case, viscosity of the plastisol is a main physical property determining a coating property in a coating process and productivity of the wallpaper, and the lower the viscosity, the more advantageous.

The volatile organic compounds generated in the vinyl chloride based wallpaper are generated from the viscosity depressant used for depressing the viscosity of the plastisol, the liquid stabilizer, and a solvent of oil based ink used in the printing process and are not almost affected by the plasticizer having a high boiling point. Particularly, in the case in which the viscosity depressant is excessively added, the viscosity depressant causes deterioration of quality of the product in addition to generation of the volatile organic compounds. Therefore, in order to reduce the generation of the volatile organic compounds, an addition amount of a liquid viscosity depressant causing the generation of the volatile organic compounds should be minimized.

The plasticizer is a liquid component accounting for the highest content in the vinyl chloride resin composition for the wallpaper, and as the plasticizer, recently, di-2-ethylhexyl phthalate (DEHP), di-isononyl phthalate (DINP), di-iso-decyl phthalate (DIDP), butyl benzyl phthalate (BBP), and di-n-butyl phthalate (DBP), which are phthalate based plasticizers, dioctyl terephthalate (DOTP), which is a non-phthalate based plasticizer, and the like, has been partially used. Among the phthalate based plasticizers, some products such as DEHP, BBP, and DBP are socially suspected as the environmental hormones, that is, endocrine disruptors inhibiting or disrupting hormone action in the human body, such that there is the trend toward regulating these products.

The case in which DOTP, which is a non-phthalate based plasticizer, is used alone or mixed with DINP to be used is disclosed in Korean Patent Laid-Open Publication No. 2008-0105341 (Patent Document 1). Since DOTP is not a phthalate based plasticizer, DOTP is free from controversy regarding the environmental hormone, but there is no advantage in view of physical properties for the wallpaper, and various problems such as a compatibility problem with the additives (the stabilizer and the viscosity depressant) used as raw materials for manufacturing the existing wallpaper, deterioration of a foaming property at the time of manufacturing the wallpaper, a rapid increase in the viscosity in winter, and the like, are discovered.

### DISCLOSURE

### Technical Problem

An object of the present invention is to provide an eco-friendly vinyl chloride resin composition containing di(2-ethylhexyl)cyclohexane-1,4-dicarboxylate (DEHCH, diethylhexylcyclohexane) plasticizer capable of preparing a plastisol having significantly low viscosity, having excellent compatibility with additives used according the related art, and minimizing generation of volatile organic compounds, as compared to a vinyl chloride composition for wallpaper using di-2-ethylhexyl phthalate, di-isononyl phthalate, or dioctyl terephthalate, which is used as a plasticizer according to the related art.

The vinyl chloride resin composition according to the present invention may minimize a phthalate based plasticizer of which there has been controversy regarding harmful effects on the environment and significantly reduce the viscosity of the plastisol by using diethylhexylcyclohexane, which is an eco-friendly plasticizer free from controversy regarding the environmental hormone. Therefore, since the vinyl chloride composition according to the present invention may reduce a usage amount of the viscosity depressant generating the volatile organic compounds having a low boiling point, the generation of the volatile organic compounds may be minimized, and volatile organic compounds generated according to the addition of other low boiling point materials may be also minimized.

Diethylhexylcyclohexane contained in the vinyl chloride resin composition according to the present invention may have a foaming property more excellent than that of the existing vinyl chloride resin composition. The present invention may provide the vinyl chloride resin composition having a more excellent foaming property than that of the existing vinyl chloride resin composition using the characteristics as described above.

Particularly, viscosity is rapidly increased in the plasticizers according to the related art in winter, such that an excess viscosity depressant needs to be additionally added. However, since the vinyl chloride resin composition according to the present invention contains diethylhexylcyclohexane, viscosity of the plastisol to which this composition is applied is not significantly increased, and low-temperature changes with the passage of time are significantly small, such that this composition may be advantageous for manufacturing an eco-friendly product.

In addition, it was discovered that the vinyl chloride resin composition according to the present invention had compatibility with other additives and also had low-temperature stability. Therefore, the vinyl chloride resin composition according to the present invention may be used for a long term/long time and have excellent low-temperature workability as compared to the existing vinyl chloride resin composition.

In the case in which the vinyl chloride resin composition as described above is used as an interior material such as wallpaper, or the like, in a state in which contents of constituents including the vinyl chloride resin, the plasticizer, and other additives are optimized, the desired excellent physical properties may be implemented.

### Technical Solution

In one general aspect, a vinyl chloride resin composition contains: 40 to 120 parts by weight of a plasticizer, 0.5 to 7 parts by weight of a stabilizer, 0.5 to 5 parts by weight of a blowing agent, 30 to 150 parts by weight of a filler, and 1 to 20 parts by weight of titanium dioxide (TiO₂), based on 100 parts by weight of a vinyl chloride resin.

More specifically, the vinyl chloride resin composition may contain 40 to 120 parts by weight of a plasticizer containing diethylhexylcyclohexane, 0.5 to 7 parts by weight of the stabilizer, 0.5 to 5 parts by weight of the blowing agent, 30 to 150 parts by weight of the filler, and 1 to 20 parts by weight of titanium dioxide (TiO₂), based on 100 parts by weight of the vinyl chloride resin.

In this case, the plasticizer may further contain dioctyl terephthalate, di-isononyl phthalate, or a mixture thereof. In detail, the plasticizer may contain diethylhexylcyclohexane, a mixture of diethylhexylcyclohexane and dioctyl terephthalate, or a mixture of diethylhexylcyclohexane and di-isononyl phthalate.

The viscosity of the vinyl chloride resin composition according to the present invention may be reduced by 40% than that of di-2-ethylhexyl phthalate, which is the representative phthalate based plasticizer, and at the time of testing the vinyl chloride resin composition depending on the group quality certification regulations of eco-friendly building materials established by Korea Air Cleaning Association, an emission amount of formaldehyde may be less than 0.015 mg/m²h and a total emission amount of the volatile organic compounds may be 0.10 mg/m²h or less.

In addition, since the vinyl chloride resin composition contains diethylhexylcyclohexane to thereby have low room-temperature and low-temperature viscosities, an excellent coating property may be implemented, the foaming property may be excellent, and generation of the volatile organic compounds may be minimized, such that stability on the environment may be high.

The vinyl chloride resin composition according to the present invention may have excellent workability and low-temperature storage stability due to the excellent low-temperature viscosity in addition to the excellent foaming property as described above, such that working conditions in winter may be easy as compared to the existing vinyl chloride resin composition. Further, the low-temperature changes with the passage of time are low, but a gelling rate is excellent. Therefore, the workability may be excellent even though thermal conditions of the existing system for preparing the vinyl chloride resin composition do not change.

The plasticizer may be a plasticizer containing diethylhexylcyclohexane. More specifically, the plasticizer may contain diethylhexylcyclohexane, the mixture of diethylhexylcyclohexane and dioctyl terephthalate, or the mixture of diethylhexylcyclohexane and di-isononyl phthalate. In detail, a mixing weight ratio of diethylhexylcyclohexane and dioctyl terephthalate may be preferably 100:0 to 10:90 by weight %, and a mixing weight ratio of diethylhexylcyclohexane and di-isononyl phthalate may be preferably 100:0 to 10:90 by weight %.

The vinyl chloride resin composition according to the present invention may reduce the viscosity at room temperature and prevent the viscosity from being increased at a low temperature during winter by using diethylhexylcyclohexane alone or using the mixture of diethylhexylcyclohexane and dioctyl terephthalate or the mixture of diethylhexylcyclohexane and di-isononyl phthalate as described above, an addition amount of a liquid viscosity depressant having high volatility may be minimized, and the compatibility with additives may be excellent. In addition, since diethylhexylcyclohexane may have a rapid gelling rate, a production rate may be improved.

The vinyl chloride resin composition according to the present invention may contain 40 to 120 parts by weight, more preferably, 70 to 90 parts by weight of the plasticizer, based on 100 parts by weight of the vinyl chloride resin. In the case in which a content of the plasticizer contained in the vinyl chloride resin composition for wallpaper according to the present invention is less than 40 parts by weight, the viscosity of the plastisol is excessively high, such that the coating property may be deteriorated and flexibility of the product may be reduced, and in the case in which the content is more than 120 parts by weight, a bleeding effect (a phenomenon that the plasticizer bleeds onto a surface of a forming product) may be easily generated, and the surface may not be completely dried to thereby be sticky, such that there may be problems in a processing process and a final product.

The vinyl chloride resin composition according to the present invention may further contain additives such as the blowing agent, the stabilizer, an auxiliary stabilizer, the filler, titanium dioxide (TiO₂), the viscosity depressant, or the like. The additive may be appropriately selected according to physical properties desired to be improved in the vinyl chloride resin composition, and the composition according to the present invention may contain at least one of the above-mentioned additives.

More specifically, the vinyl chloride resin composition according to the present invention may contain 40 to 120 parts by weight of the plasticizer, 0.5 to 7 parts by weight of the stabilizer, 0.5 to 5 parts by weight of the blowing agent, 30 to 150 parts by weight of the filler, and 1 to 20 parts by weight of titanium dioxide (TiO₂), based on 100 parts by weight of the vinyl chloride resin.

The stabilizer may be added in order to prevent various physical property changes generated as HCl is separated from polyvinyl chloride to form a polyene structure, which is a chromophore, and then generate a cutting and cross-linking phenomenon in a main chain and include at least one selected from a group consisting of Ca—Zn based compounds, K—Zn based compounds, Ba—Zn based compounds, organic Tin based compounds, metallic soap based compounds, phenolic compounds, phosphoric acid ester based compounds, and phosphorous acid ester based compounds. A specific example of the stabilizer capable of being used in the present invention may include the Ca—Zn based compounds; K—Zn based compounds; the Ba—Zn based compounds; organic Tin based compounds such as mercaptide based compounds, maleic acid based compound, or carboxylic acid based compound; the metallic soap based compounds such as Mg-stearate, Ca-stearate, Pb-stearate, Cd-stearate, or Ba-stearate, and the like; the phenolic compounds; the phosphoric acid ester based compounds; the phosphorous acid ester based compounds, and the like, and these stabilizers may be selectively contained according to the using purposes. In the present invention, particularly, the Ca—Zn based compounds and the K—Zn based compounds, preferably, Ca—Zn composite organic compounds, K—Zn based composite organic compounds may be used.

The vinyl chloride resin, which is the interpolymer containing the vinyl chloride homopolymer and vinyl chloride at a content of 50% or more, is one of the five major thermoplastic plastic resins prepared by suspension polymerization and emulsion polymerization. The vinyl chloride resin used in the present invention is a resin prepared by micro-suspension polymerization or emulsion polymerization and a degree of polymerization thereof is 900 to 1700.

A content of the contained stabilizer may be preferably 0.5 to 7 parts by weight, more preferably 1 to 4 parts by weight, based on 100 parts by weight of the vinyl chloride resin. In the case in which the content of the stabilizer is less than 0.5 parts by weight, thermal stability may be reduced, and in the case in which the content is more than 7 parts by weight, thermal stability may be excessively exhibited.

The blowing agent used in the present invention may include at least one selected from a chemical blowing agent, a physical blowing agent, or a mixture thereof.

As the chemical blowing agent, any compound is not particularly limited as long as the compound may be decomposed at a specific temperature or more to generate gas, and an example thereof may include azodicarbonamide, azodi-isobutyro-nitrile, benzenesulfonhydrazide, 4,4-oxybenzene sulfonyl-semicarbazide, p-toluene sulfonyl semi-carbazide, barium azodicarboxylate, N,N′-dimethyl-N,N′-dinitrosoterephthalamide, trihydrazino triazine, and the like. In addition, the example of the chemical blowing agent may include sodium bicarbonate, potassium bicarbonate, ammonium bicarbonate, sodium carbonate, ammonium carbonate, and the like.

Further, examples of the physical blowing agent may include an inorganic blowing agent such as carbon dioxide, nitrogen, argon, water, air, helium, or the like, or an organic blowing agent such as aliphatic hydrocarbon containing 1 to 9 carbon atoms, aliphatic alcohol containing 1 to 3 carbon atoms, and halogenated aliphatic hydrocarbon containing 1 to 4 carbon atoms. Specific examples of the above-mentioned compounds may be as follows: Examples of the aliphatic hydrocarbon compounds may include methane, ethane, propane, normal butane, isobutene, normal pentane, isopentane, neopentane, and the like, examples of the aliphatic alcohols may include methanol, ethanol, normal propanol, isopropanol, and the like, and examples of the halogenated aliphatic hydrocarbon compounds may include methyl fluoride, perfluoromethane, ethyl fluoride, 1,1-difluoroethane (HFC-152a), 1,1,1-trifluoroethane (HFC-143a), 1,1,1,2-tetrafluoroethane (HFC-134a), 1,1,2,2-tetrafluoromethane (HFC-134), 1,1,1,3,3-pentafluorobutane (HFC-365mfc), 1,1,1,3,3-pentafluoropropane (HFC.sub.13 245fa), pentafluoroethane, difluoromethane, perfluoroethane, 2,2-difluoropropane, 1,1,1-trifluoropropane, perfluoropropane, dichloropropane, difluoropropane, perfluorobutane, perfluorocyclobutane, methyl chloride, methylene chloride, ethyl chloride, 1,1,1-trichloroethane, 1,1-dichloro-1-fluoroethane, (HCFC-141b), 1-chloro-1,1-difluoroethane (HCFC-142b), chlorodifluoromethane (HCFC-22), 1,1-dichloro-2,2,2-trifluoroethane (HCFC-123), 1-chloro-1,2,2,2-tetrafluoroethane (HCFC-124), trichloromonofluoromethane (CFC-11), dichlorodifluoromethane (CFC-12), trichlorotrifluoroethane (CFC-113), 1,1,1-trifluoroethane, pentafluoroethane, dichlorotetrafluoroethane (CFC-114), chloroheptafluoropropane, dichlorohexafluoropropane, and the like. A content of the blowing agent as described above may be preferably 0.5 to 5 parts by weight, based on 100 parts by weight of the vinyl chloride resin. In the case in which the content is excessively low, an amount of generated gas for foaming is excessively small, such that a foaming effect may be insignificant or not obtained, and in the case in which the content is excessively high, the amount of generated gas is excessively large, such that it may be difficult to obtain the desired physical property.

The filler of the present invention may be used in order to improve productivity of the vinyl chloride resin composition and a dry touch property and include at least one selected from a group consisting of calcium carbonate, talc, titanium dioxide, kaolin, silica, alumina, magnesium hydroxide, and clay.

The vinyl chloride resin composition according to the present invention may contain the viscosity depressant, as needed. More specifically, an ester based viscosity depressant may be used.

In the vinyl chloride resin composition according to the present invention, a content of the filler may be preferably 30 to 150 parts by weight, more preferably 50 to 130 parts by weight. In the case in which the content of the contained filler is less than 50 parts by weight, dimensional stability and economical efficiency may be reduced, and in the case in which the content is more than 130 parts by weight, a foaming surface may not be good, and processability may be deteriorated.

Whiteness and a hiding property may be improved by adding titanium dioxide (TiO₂) in the vinyl chloride resin composition according to the present invention. A content of the contained titanium dioxide may be preferably 1 to 20 parts by weight, more preferably 3 to 15 parts by weight, based on 100 parts by weight of the vinyl chloride resin. In the case in which the content of the contained titanium dioxide is less than 3 parts by weight, the whiteness and hiding property may be deteriorated, such that after printing, colors may not be implemented as desired, and in the case in which the content is more than 15 parts by weight, the foaming surface may be deteriorated.

The vinyl chloride resin composition according to the present invention may be prepared using the vinyl chloride resin, the plasticizer, and selective additives by a general method, and the method is not particularly limited.

As described above, the vinyl chloride resin composition according to the present invention may be eco-friendly and have an excellent foaming property and workability, such that the vinyl chloride resin composition may be widely applied to interior materials, for example, a wallpaper, artificial leather, a floor material, or the like.

### Advantageous Effects

As described above, the vinyl chloride resin composition prepared according to the present invention may be free from controversy regarding the environment by using diethylhexylcyclohexane, which is the non-phthalate based plasticizer substituting for the controversial phthalate based plasticizer.

In addition, the vinyl chloride resin composition using diethylhexylcyclohexane may have a significantly low initial viscosity and low-temperature viscosity and generate less the volatile organic compounds (VOCs), as compared to the existing phthalate based plasticizer and dioctyl terephthalate, which is the non-phthalate based plasticizer, such that the vinyl chloride resin composition may be advantageous for developing eco-friendly products.

Particularly, the vinyl chloride resin composition according to the present invention may have excellent compatibility with additive. In addition, since diethylhexylcyclohexane may have a rapid gelling rate, a production rate may be improved. Further, there is an advantage in that the product may be prepared under the same conditions as those for preparing a plastisol using di-2-ethylhexyl phthalate that is mainly used in the art.

Furthermore, the vinyl chloride resin composition according to the present invention may be eco-friendly and have a significantly excellent foaming property and workability, such that the vinyl chloride resin composition may be used to manufacture floor materials, artificial leather, or the like, as well as wallpaper, and widely applied to the floor materials.

### DESCRIPTION OF DRAWINGS

FIG. 1 shows results obtained by measuring low-temperature storage stability of plasticizers (DEHP, DEHCH, DINP, and DOTP).

FIG. 2 shows results obtained by comparing gelling rates of the plasticizers (DEHP, DEHCH, DINP, and DOTP) with each other.

### BEST MODE

The present invention will be described in detail by Examples.

However, the following Examples are to illustrate the present invention, and the scope of the present invention is not limited to the following Examples.

(Evaluation)

Viscosity Measurement

After the prepared plastisol was left in a constant temperature oven at 25° C. for 1 hour, the viscosity of the plastisol was measured using a Brookfield viscometer (spindle #6, 20, 5 RPM). In addition, after the prepared plastisol was stored in a refrigerator at −5° C., the viscosity with the passage of time was evaluated.

A viscosity change with the passage of time means a ratio of an initial viscosity and a viscosity after 1 day, and a viscosity change with the passage of time at a lower temperature means a degree of a viscosity change at −5° C. after 1 day.

Foaming Surface and Foaming Cell Measurement

A foaming property is the most important factor in foaming products. The foaming property means a property indicating a surface state of the product, a size of a foaming cell, and uniformity of the cell. The plastisol according to the present invention was coated onto paper at a thickness of 0.2 mm using an applicator and then heated in an oven at 220° C. for 40 seconds to perform the foaming, thereby manufacturing a foaming sheet. The surface state of the foaming sheet manufactured as described above was observed by the naked eyes, and the foaming cells were photographed and observed using an electron microscope. The results were represented by the following symbols.

(Very good)⊚>∘>Δ>X(very poor)

Whiteness Measurement main factor indicating definition of color during a color matching process, was measured using a colorimeter and then arithmetically expressed.

Thermal Stability Measurement

After the plastisol was coated onto the paper at a thickness of 0.2 mm using an applicator and then heated in an oven at 220° C. for 60 to 100 seconds, observation was performed at a timing point at which the yellowing starts, and the thermal stability was compared through relative comparison. The thermal stability was classified according to the following standard.

(Very good)⊚>∘>Δ>X(very poor)

Low-Temperature Characteristics Evaluation

After a plasticizer was injected into a 50 ml vial and left at −15° C. for 4 hours, the plasticizer is picked out and an appearance thereof was observed by the naked eyes.

Gelling Rate Measurement

A gelling rate of the prepared plastisol was measured at 110° C. using a scanning vibrating needle curemeter (SVNC). As the gelling progressed in the SVNC, amplitude was reduced. The gelling rate was compared and measured using a rate of reducing this value.

HB Mark

The HB mark is a mark given to a product according to the results obtained by allowing an accredited laboratory to strictly and thoroughly perform a quality certification test on emission intensity of organic compounds (total volatile organic carbon (TVOC), formaldehyde (HCHO)) depending on the group quality certification regulations of eco-friendly building materials established by Korea Air Cleaning Association. The certification grade of the wallpaper was determined by the following Table and expressed as the number of clovers in a certification mark. The case in which the number of clovers was 5, the case in which the number of clovers was 4, the case in which the number of clovers was 3, the case in which the number of clovers was 2, and the case in which the number of clovers was 1 were classified into most excellent, excellent, good, fair I, and fair II, respectively.

TABLE 1

| | |
|---|---|
| Classification | General material (wallpaper) |

| | | |
|---|---|---|
| Most | TVOC | Less than 0.10 |
| excellent | HCHO | Less than 0.03 |
| Excellent | TVOC | 0.10 or more to less than 0.2 |
| | HCHO | 0.03 or more to less than 0.05 |
| Good | TVOC | 0.20 or more to less than 0.40 |
| | HCHO | 0.05 or more to less than 0.12 |
| Fair I | TVOC | 0.40 or more to less than 2.00 |
| | HCHO | 0.12 or more to less than 0.60 |
| Fair II | TVOC | 2.00 or more to less than 4.00 |
| | HCHO | 0.60 or more to less than 1.25 |

### Example 1

Based on 100 parts by weight of a vinyl chloride resin (emulsion polymerization resin having a degree of polymerization of 900), 60 parts by weight of diethylhexylcyclohexane as a plasticizer, 3 parts by weight of K/Zn based composite stabilizer (KKZ102 PF, Woochang Chem. Co.), 3 parts by weight of an azodicarbonamide blowing agent (DWPX03, Dongjin Semichem), 5 parts by weight of an ester based viscosity depressant (V5125, BYK Corp.), 10 parts by weight of TiO₂ (R902, Dupont Corp.), and 100 parts by weight of calcium carbonate (OM-10, Omya Korea) having an average particle size of 10 μm were mixed in a Mathis mixer for 10 minutes to prepare a plastisol. Then, physical properties were evaluated by the measuring methods described above, and the results were shown in Table 2.

### Example 2

A plastisol was prepared by the same method as that in Example 1 except for using 70 parts by weight of diethylhexylcyclohexane as the plasticizer, and the results were shown in Table 2.

### Example 3

A plastisol was prepared by the same method as that in Example 1 except for using 80 parts by weight of diethylhexylcyclohexane as the plasticizer, and the results were shown in Table 2.

### Example 4

A plastisol was prepared by the same method as that in Example 1 except for using 90 parts by weight of diethylhexylcyclohexane as the plasticizer, and the results were shown in Table 2.

### Comparative Example 1

A plastisol was prepared by the same method as that in Example 1 except for using 70 parts by weight of di-2-ethylhexyl phthalate as the plasticizer instead of diethylhexylcyclohexane, and the results were shown in Table 2.

### Comparative Example 2

A plastisol was prepared by the same method as that in Example 1 except for using 70 parts by weight of di-isononyl phthalate as the plasticizer instead of diethylhexylcyclohexane, and the results were shown in Table 2.

### Comparative Example 3

A plastisol was prepared by the same method as that in Example 1 except for using 70 parts by weight of dioctyl terephthalate as the plasticizer instead of diethylhexylcyclohexane, and the results were shown in Table 2.

TABLE 2

| | | | | | Comparative | Comparative | Comparative |
|---|---|---|---|---|---|---|---|
| | Example 1 | Example 2 | Example 3 | Example 4 | Example 1 | Example 2 | Example 3 |
| Initial | 9,700 | 5,450 | 3,500 | 1,850 | 10,100 | 9,100 | 8,750 |
| viscosity (CPS) | | | | | | | |
| Room- | 1.15 | 1.09 | 1.09 | 1.14 | 1.14 | 1.14 | 1.06 |
| temperature | | | | | | | |
| viscosity | | | | | | | |
| change ratio | | | | | | | |
| with the | | | | | | | |
| passage of time | | | | | | | |
| Low- | 56,400 | 24,800 | 16,200 | 10,000 | 87,200 | 76,500 | 66,800 |
| temperature | | | | | | | |
| viscosity (CPS, −5° C.) | | | | | | | |
| Low- | 5.81 | 4.55 | 4.63 | 5.41 | 8.63 | 8.41 | 7.63 |
| temperature | | | | | | | |
| viscosity | | | | | | | |
| change ratio | | | | | | | |
| with the | | | | | | | |
| passage of time | | | | | | | |
| Process | 9,070 | 3,950 | 2,170 | 1,320 | 8,160 | 7,330 | 7,570 |
| viscosity (CPS, | | | | | | | |
| 500 sec⁻¹) | | | | | | | |
| Foaming | ⊚ | ⊚ | ⊚ | ⊚ | ⊚ | ◯ | ◯ |
| property | | | | | | | |
| Thermal | ⊚ | ◯ | ◯ | Δ | ◯ | Δ | ⊚ |
| stability | | | | | | | |
| Whiteness | 91.2 | 91.0 | 91.1 | 90.8 | 91.4 | 91.2 | 91.0 |
| TVOC | 0.04 | 0.05 | 0.07 | 0.10 | 0.09 | 0.08 | 0.10 |
| HCHO | 0.001 | 0.002 | 0.001 | 0.002 | 0.001 | 0.001 | 0.002 |

As shown in Table 2, the plastisols prepared in Examples 1 to 4 in which diethylhexylcyclohexane was used as the plasticizer had a significantly low viscosity as compared to the plastisols prepared in Comparative Examples 1 to 3 in which di-2-ethylhexyl phthalate and di-isononyl phthalate, which are phthalate based plasticizers, and dioctyl terephthalate, which is an eco-friendly plasticizer, were used, and particularly, the viscosity was about 50% as compared to di-2-ethylhexyl phthalate.

The process viscosity, which is a viscosity when the plastisol passes through a coater at the time of manufacturing the wallpaper, is a very important property value in a manufacturing process of the wallpaper. It may be confirmed that the process viscosity in Examples 1 to 4 according to the present invention was significantly low. In addition, a difference in the room-temperature viscosity change with the passage of time between the plasticizers to be compared was not large.

In the case in which the viscosity of the plasticizer increased while a temperature decreased during winter, as a method of reducing a viscosity as compared to the viscosity during summer in order to prevent this case, a liquid additive was excessively added. However, in this case, there were problems such as an increase in cost and generation of volatile organic compounds (VOCs). Therefore, the lower is the viscosity of the plasticizer during winter, the more suitable the plasticizer is for manufacturing eco-friendly wallpaper. In this regard, the low-temperature viscosity and the low-temperature viscosity change with the passage of time were significantly low in Examples 1 to 4 in which diethylhexylcyclohexane was used as the plasticizer as compared to Comparative Examples 1 to 3, such that it may be confirmed that the plasticizers of Examples 1 to 4 were excellent. Particularly, since the low-temperature viscosity and the low-temperature viscosity change with the passage of time were significantly low as compared to Comparative Example 3 in which dioctyl terephthalate, which has been used as the eco-friendly plasticizer, was used as the plasticizer, low viscosity characteristics of diethylhexylcyclohexane may be further highlighted during winter.

All of the foaming properties in Examples 1 to 4 were significantly excellent and similar to those in Comparative Examples 1 to 3.

The thermal stability of diethylhexylcyclohexane was more excellent than that of di-isononyl phthalate, similar to that of dioctyl phthalate, and slightly lower than that of dioctyl terephthalate. However, since thermal stability of di-isononyl phthalate does not cause a problem in a manufacturing process of polyvinyl chloride (PVC) wallpaper, the thermal stability of diethylhexylcyclohexane does not matter in a manufacturing process of the wallpaper.

The whiteness in all of the Examples and Comparative Examples were similar.

Describing the results obtained by evaluating the physical properties according to the content of diethylhexylcyclohexane in Examples 1 to 4 and Comparative Examples 1 to 3, the viscosity and physical properties in the case in which 60 parts by weight of diethylhexylcyclohexane was mixed were similar to those in the case in which 70 parts by weight of di-2-ethylhexyl phthalate was mixed. Therefore, in the case of using diethylhexylcyclohexane, an addition amount of the plasticizer may be reduced by approximately 10 parts by weight.

Further, an addition amount of the viscosity depressant additionally added in order to control the viscosity in a wallpaper manufacturing factory may be reduced, which may be advantageous for manufacturing the eco-friendly wallpaper. In addition, a possibility that the VOC will be generated may be reduced by reducing the addition amount of the viscosity depressant, and a tacky phenomenon generated during the manufacturing process of the wallpaper may be prevented.

The following Examples 5 to 10 were to evaluate a mixing possibility of diethylhexylcyclohexane and dioctyl terephthalate as the plasticizer, and the evaluation was performed while controlling a mixing ratio of diethylhexylcyclohexane and dioctyl terephthalate.

### Example 5

A plastisol was prepared by the same method as that in Example 1 except for using 60 parts by weight of diethylhexylcyclohexane and 10 parts by weight of dioctyl terephthalate as the plasticizer, and the results were shown in Table 3.

### Example 6

A plastisol was prepared by the same method as that in Example 1 except for using 50 parts by weight of diethylhexylcyclohexane and 20 parts by weight of dioctyl terephthalate as the plasticizer, and the results were shown in Table 3.

### Example 7

A plastisol was prepared by the same method as that in Example 1 except for using 40 parts by weight of diethylhexylcyclohexane and 30 parts by weight of dioctyl terephthalate as the plasticizer, and the results were shown in Table 3.

### Example 8

A plastisol was prepared by the same method as that in Example 1 except for using 30 parts by weight of diethylhexylcyclohexane and 40 parts by weight of dioctyl terephthalate as the plasticizer, and the results were shown in Table 3.

### Example 9

A plastisol was prepared by the same method as that in Example 1 except for using 20 parts by weight of diethylhexylcyclohexane and 50 parts by weight of dioctyl terephthalate as the plasticizer, and the results were shown in Table 3.

### Example 10

A plastisol was prepared by the same method as that in Example 1 except for using 10 parts by weight of diethylhexylcyclohexane and 60 parts by weight of dioctyl terephthalate as the plasticizer, and the results were shown in Table 3.

TABLE 3

| | Example 5 | Example 6 | Example 7 | Example 8 | Example 9 | Example 10 |
|---|---|---|---|---|---|---|
| Initial viscosity | 5,050 | 5,400 | 5,850 | 6,800 | 7,250 | 7,500 |
| (CPS) | | | | | | |
| Room-temperature | 1.08 | 1.05 | 1.05 | 1.06 | 1.05 | 1.09 |
| viscosity change | | | | | | |
| ratio with the | | | | | | |
| passage of time | | | | | | |
| Low-temperature | 31,350 | 34,050 | 38,750 | 43,200 | 46,450 | 54,000 |
| viscosity (CPS, −5° C.) | | | | | | |
| Low-temperature | 4.63 | 4.86 | 4.98 | 4.53 | 4.50 | 4.89 |
| viscosity change | | | | | | |
| ratio with the | | | | | | |
| passage of time | | | | | | |
| Process viscosity | 4,130 | 4,530 | 4,990 | 5,460 | 6,040 | 6,810 |
| (CPS, 500 sec⁻¹) | | | | | | |
| Foaming property | ⊚ | ⊚ | ⊚ | ⊚ | ◯ | ◯ |
| Thermal stability | ◯ | ◯ | ⊚ | ⊚ | ⊚ | ⊚ |
| Whiteness | 91.0 | 90.9 | 91.0 | 91.0 | 91.0 | 91.0 |
| TVOC | 0.05 | 0.06 | 0.06 | 0.07 | 0.08 | 0.08 |
| HCHO | 0.001 | 0.001 | 0.001 | 0.001 | 0.001 | 0.001 |

As shown in Table 3, in the case in which dioctyl terephthalate was mixed with diethylhexylcyclohexane, as the content of dioctyl terephthalate was increased, the viscosity was increased, and the low-temperature viscosity and the low-temperature viscosity change with the passage of time were slightly increased. Particularly, comparing Examples 5 to 10 with Comparative Example 3, in the case in which a small amount (10 weight % or more) of dioctyl terephthalate was mixed with diethylhexylcyclohexane, the low-temperature viscosity change with the passage of time was significantly reduced, as compared to the case of using dioctyl terephthalate alone.

As the content of dioctyl terephthalate was increased, the foaming property was slightly reduced, which did not cause problems, and it may be confirmed that thermal stability was improved. Therefore, through the Examples 5 to 10 according to the present invention, it may be confirmed that in the case in which the mixture of diethylhexylcyclohexane and dioctyl terephthalate was contained at a content of 70 parts by weight, based on 100 parts by weight of the vinyl chloride resin, a preferable mixing ratio was 70:0 to 10:60.

The following Examples 11 to 16 were to evaluate a mixing possibility of diethylhexylcyclohexane and di-isononyl phthalate as the plasticizer, and the evaluation was performed while controlling a mixing ratio of diethylhexylcyclohexane and di-isononyl phthalate.

### Example 11

A plastisol was prepared by the same method as that in Example 1 except for using 60 parts by weight of diethylhexylcyclohexane and 10 parts by weight of di-isononyl phthalate as the plasticizer, and the results were shown in Table 4.

### Example 12

A plastisol was prepared by the same method as that in Example 1 except for using 50 parts by weight of diethylhexylcyclohexane and 20 parts by weight of di-isononyl phthalate as the plasticizer, and the results were shown in Table 4.

### Example 13

A plastisol was prepared by the same method as that in Example 1 except for using 40 parts by weight of diethylhexylcyclohexane and 30 parts by weight of di-isononyl phthalate as the plasticizer, and the results were shown in Table 4.

### Example 14

A plastisol was prepared by the same method as that in Example 1 except for using 30 parts by weight of diethylhexylcyclohexane and 40 parts by weight of di-isononyl phthalate as the plasticizer, and the results were shown in Table 4.

### Example 15

A plastisol was prepared by the same method as that in Example 1 except for using 20 parts by weight of diethylhexylcyclohexane and 50 parts by weight of di-isononyl phthalate as the plasticizer, and the results were shown in Table 4.

### Example 16

A plastisol was prepared by the same method as that in Example 1 except for using 10 parts by weight of diethylhexylcyclohexane and 60 parts by weight of di-isononyl phthalate as the plasticizer, and the results were shown in Table 4.

### Example 17

Based on 100 parts by weight of a vinyl chloride resin (emulsion polymerization resin having a degree of polymerization of 900), 70 parts by weight of diethylhexylcyclohexane as a plasticizer, 3 parts by weight of K/Zn based composite stabilizer (KKZ102 PF, Woochang Chem. Co.), 3 parts by weight of an azodicarbonamide blowing agent (DWPX03, Dongjin Semichem), 10 parts by weight of TiO₂ (R902, Dupont Corp.), and 100 parts by weight of calcium carbonate (OM-10, Omya Korea) having an average particle size of 10 μm were mixed in a Mathis mixer for 10 minutes to prepare a plastisol. Then, physical properties were evaluated by the measuring methods described above, and the results were shown in Table 4.

TABLE 4

| | Example | Example | Example | Example | Example | Example | Example |
|---|---|---|---|---|---|---|---|
| | 11 | 12 | 13 | 14 | 15 | 16 | 17 |
| Initial | 6,050 | 6,650 | 7,200 | 7,650 | 8,350 | 8,750 | 10,200 |
| viscosity (CPS) | | | | | | | |
| Room- | 1.12 | 1.08 | 1.10 | 1.08 | 1.10 | 1.14 | 1.07 |
| temperature | | | | | | | |
| viscosity | | | | | | | |
| change ratio | | | | | | | |
| with the | | | | | | | |
| passage of time | | | | | | | |
| Low- | 37,000 | 42,000 | 47,600 | 50,800 | 57,800 | 66,800 | 52,100 |
| temperature | | | | | | | |
| viscosity (CPS, −5° C.) | | | | | | | |
| Low- | 3.63 | 3.89 | 3.90 | 4.03 | 4.13 | 4.45 | 3.52 |
| temperature | | | | | | | |
| viscosity | | | | | | | |
| change ratio | | | | | | | |
| with the | | | | | | | |
| passage of time | | | | | | | |
| Process | 3.530 | 4,080 | 4,460 | 4,760 | 5,060 | 5,410 | 5,320 |
| viscosity (CPS, | | | | | | | |
| 500 sec⁻¹) | | | | | | | |
| Foaming | ⊚ | ⊚ | ⊚ | ⊚ | ⊚ | ⊚ | ⊚ |
| property | | | | | | | |
| Thermal | ◯ | ◯ | ◯ | ◯ | ◯ | ◯ | ◯ |
| stability | | | | | | | |
| Whiteness | 91.1 | 91.0 | 91.1 | 91.2 | 91.2 | 91.3 | 91.1 |
| TVOC | 0.06 | 0.05 | 0.06 | 0.07 | 0.07 | 0.08 | 0.02 |
| HCHO | 0.001 | 0.001 | 0.001 | 0.002 | 0.001 | 0.001 | 0.001 |

As shown in Table 4, in the cases in which di-isononyl phthalate was mixed with diethylhexylcyclohexane, as the content of di-isononyl phthalate was increased, the viscosity was increased, and the low-temperature viscosity and the low-temperature viscosity change with the passage of time were slightly increased, but a change in the foaming property was not significant. In addition, comparing Examples 11 to 16 with Comparative Example 2, when a small amount (10 weight % or more) of di-isononyl phthalate was mixed with diethylhexylcyclohexane, the low-temperature viscosity change with the passage of time was significantly reduced, as compared to the case of using di-isononyl phthalate alone.

Therefore, through the Examples 11 to 17 according to the present invention, it may be confirmed that in the case in which the mixture of diethylhexylcyclohexane and di-isononyl phthalate was contained at a content of 70 parts by weight, based on 100 parts by weight of the vinyl chloride resin, a preferable mixing ratio was 70:0 to 10:60.

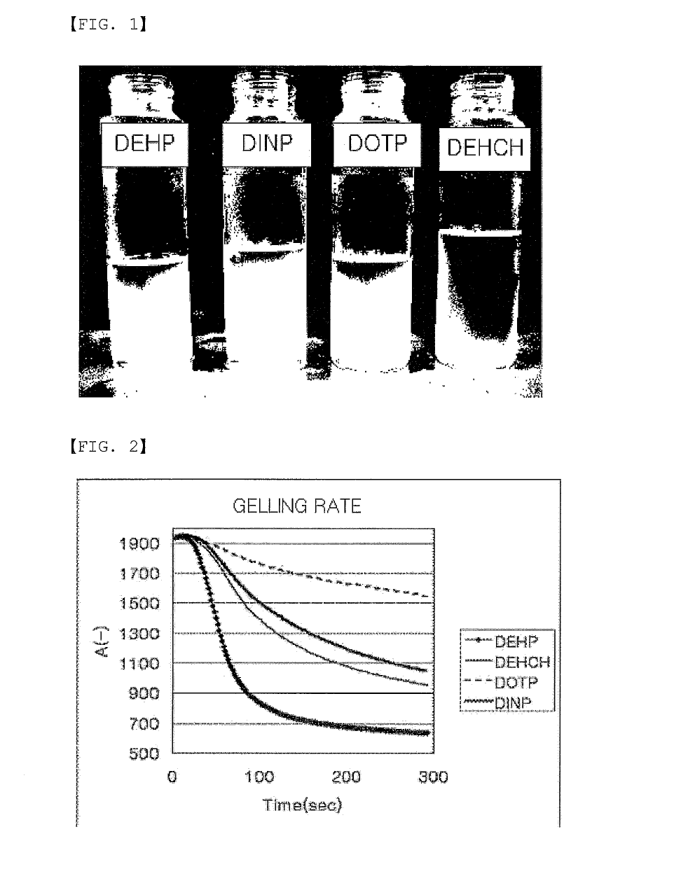

Low-temperature characteristics (−15° C.) of the plasticizers used in the present invention were evaluated through the above Examples. As a result, as shown in FIG. 1, it was confirmed that low-temperature storage stability of the plasticizers was excellent in a sequence of diethylhexylcyclohexane, di-2-ethylhexyl phthalate, dioctyl terephthalate, and di-isononyl phthalate, and in the case of diethylhexylcyclohexane, since storage stability during winter in which there was a problem in the case of the existing phthalate based plasticizers and dioctyl terephthalate was significantly excellent, at the time of preparing the plastisol in winter, a decrease in a mixing time and an effect of decreasing the viscosity may be expected. In the case of diethylhexylcyclohexane, a phase change was not large at the low temperature, but the other plasticizers were partially congealed. In the present invention, diethylhexylcyclohexane was not congealed even at −15° C. Therefore, it may be confirmed that diethylhexylcyclohexane had an excellent low-temperature viscosity change property with the passage of time due to the excellent low-temperature characteristics as described above.

In the case of Example 17 in which diethylhexylcyclohexane was used alone and the viscosity depressant was not used, since the viscosity was not used, the initial viscosity was relatively high, the process viscosity, the room-temperature viscosity change with the passage of time, the low-temperature viscosity change with the time, and TVOC and HCHO values were excellent.

In addition, the results obtained by comparing gelling rates of the plasticizers used in the present invention were shown in FIG. 2, and the gelling rate was excellent in a sequence of di-2-ethylhexyl phthalate, diethylhexylcyclohexane, di-isononyl phthalate, and dioctyl terephthalate. The gelling rate of diethylhexylcyclohexane of the present invention was similar to that of di-2-ethylhexyl phthalate, which is a representative plasticizer, and significantly faster than those of di-isononyl phthalate and dioctyl terephthalate. Therefore, diethylhexylcyclohexane may be used in the existing manufacturing process of the wallpaper without particularly changing thermal conditions.

Hereinabove, although the present invention is described by specific matters, exemplary embodiments, and drawings, they are provided only for assisting in the entire understanding of the present invention. Therefore, the present invention is not limited to the exemplary embodiments. Various modifications and changes may be made by those skilled in the art to which the present invention pertains from this description.

Therefore, the spirit of the present invention should not be limited to the above-described exemplary embodiments, and the following claims as well as all modified equally or equivalently to the claims are intended to fall within the scope and spirit of the invention.

1. A vinyl chloride resin composition comprising:
40 to 120 parts by weight of a plasticizer including diethylhexylcyclohexane;
0.5 to 7 parts by weight of a stabilizer;
0.5 to 5 parts by weight of a blowing agent;
30 to 150 parts by weight of a filler; and
1 to 20 parts by weight of titanium dioxide (TiO₂), based on 100 parts by weight of a vinyl chloride resin.

2. The vinyl chloride resin composition of claim 1, wherein the plasticizer further includes dioctyl terephthalate, di-isononyl phthalate, or a mixture thereof.

3. The vinyl chloride resin composition of claim 1, wherein the stabilizer is at least one selected from a group consisting of Ca—Zn based compounds, K—Zn based compounds, Ba—Zn based compounds, organic Tin based compounds, metallic soap based compounds, phenolic compounds, phosphoric acid ester based compounds, and phosphorous acid ester based compounds.

4. The vinyl chloride resin composition of claim 1, wherein the blowing agent is at least one selected from a chemical blowing agent, a physical blowing agent, and a mixture thereof.

5. The vinyl chloride resin composition of claim 1, wherein the filler is at least one selected from a group consisting of calcium carbonate, talc, titanium dioxide, kaolin, silica, alumina, magnesium hydroxide, and clay.

6. The vinyl chloride resin composition of claim 1, wherein in the vinyl chloride resin composition, an emission amount of formaldehyde is less than 0.015 mg/m²h, and a total emission amount of the volatile organic compounds is 0.10 mg/m²h or less.

7. An interior material comprising the vinyl chloride resin composition of claim 1.

8. An interior material comprising the vinyl chloride resin composition of claim 2.

9. An interior material comprising the vinyl chloride resin composition of claim 3.

10. An interior material comprising the vinyl chloride resin composition of claim 4.

11. An interior material comprising the vinyl chloride resin composition of claim 5.

12. An interior material comprising the vinyl chloride resin composition of claim 6.

13. The interior material of claim 7, wherein it includes wallpaper, artificial leather, and floor materials.

14. The interior material of claim 8, wherein it includes wallpaper, artificial leather, and floor materials.

15. The interior material of claim 9, wherein it includes wallpaper, artificial leather, and floor materials.

16. The interior material of claim 10, wherein it includes wallpaper, artificial leather, and floor materials.

17. The interior material of claim 11, wherein it includes wallpaper, artificial leather, and floor materials.

18. The interior material of claim 12, wherein it includes wallpaper, artificial leather, and floor materials.
